(19) United States
(12) Patent Application Publication
(10) Pub. No.: US 2024/0126123 A1
(43) Pub. Date: Apr. 18, 2024

(54) ELECTRONIC DEVICE AND MANUFACTURING METHOD THEREOF

(71) Applicant: InnoLux Corporation, Miao-Li County (TW)

(72) Inventors: Chiung-Chieh KUO, Miao-Li County (TW); Chi-Han HSIEH, Miao-Li County (TW); Hsiang-Wen HSUEH, Miao-Li County (TW); Shu-Hung SHEN, Miao-Li County (TW)

(73) Assignee: InnoLux Corporation, Miao-Li County (TW)

(21) Appl. No.: 18/243,677

(22) Filed: Sep. 8, 2023

Related U.S. Application Data
(60) Provisional application No. 63/416,945, filed on Oct. 18, 2022.

(30) Foreign Application Priority Data
Jul. 18, 2023 (CN) 202310878067.4

(51) Int. Cl. G02F 1/1339

(52) U.S. Cl. CPC G02F 1/13396; G02F 1/13394; G02F 1/13398; G02F 1/1368

(57) ABSTRACT

This disclosure provides an electronic device and a manufacturing method thereof. The electronic device includes a first substrate, a second substrate, a first supporting member and a plurality of second supporting members. The first supporting member and the second supporting members are disposed between the first substrate and the second substrate. The first supporting member includes a first bottom surface and a first top surface. The second supporting member is disposed adjacent to the first supporting member and includes a second bottom surface and a second top surface. The difference between the radius of the first bottom surface and the radius of the first top surface is defined as a first radius bias. The difference between the radius of the second bottom surface and the radius of the second top surface is defined as a second radius bias. The first radius bias is greater than the second radius bias.

### CROSS REFERENCE TO RELATED APPLICATION

This application claims the benefit of U.S. Provisional Application No. 63/416,945, filed on Oct. 18, 2022. The content of the application is incorporated herein by reference.

### BACKGROUND OF THE DISCLOSURE

### 1. Field of the Disclosure

The present disclosure relates to an electronic device and a manufacturing method thereof, and more particular to an electronic device including supporting members and a manufacturing method thereof.

### 2. Description of the Prior Art

In some electronic devices, the electronic device may include supporting members to maintain the internal space of the electronic device. However, the internal space of the electronic device cannot be effectively maintained when the supporting members cannot fully rebound after being compressed by external force, and the electronic device may be damaged. Therefore, how to effectively improve the support function of the supporting members to improve the quality or reliability of the electronic device is one of the technical problems that needs to be solved at present.

### SUMMARY OF THE DISCLOSURE

One of the embodiments of the present disclosure provides an electronic device including a first substrate, a second substrate, a first supporting member and a plurality of second supporting members. The second substrate is disposed opposite to the first substrate. The first supporting member is disposed between the first substrate and the second substrate, and the first supporting member includes a first bottom surface and a first top surface. The plurality of second supporting members are disposed between the first substrate and the second substrate, the plurality of second supporting members are disposed adjacent to the first supporting member, and one of the plurality of second supporting members includes a second bottom surface and a second top surface. A difference between a radius of the first bottom surface and a radius of the first top surface is defined as a first radius bias, a difference between a radius of the second bottom surface and a radius of the second top surface is defined as a second radius bias, and the first radius bias is greater than the second radius bias.

One of the embodiments of the present disclosure provides a manufacturing method of an electronic device which includes following steps: providing a first substrate and a second substrate; forming a first supporting member and a plurality of second supporting members on the first substrate or the second substrate through a photomask, the photomask includes a first pattern and a plurality of second patterns, the first pattern is used for forming the first supporting member, and the plurality of second patterns are used for forming the plurality of second supporting members; and combining the first substrate and the second substrate, the second substrate is disposed opposite to the first substrate, and the first supporting member and the plurality of second supporting members are disposed between the first substrate and the second substrate, the first supporting member includes a first bottom surface and a first top surface, one of the plurality of second supporting members includes a second bottom surface and a second top surface, a difference between a radius of the first bottom surface and a radius of the first top surface is defined as a first radius bias, a difference between a radius of the second bottom surface and a radius of the second top surface is defined as a second radius bias, and the first radius bias is greater than the second radius bias.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a schematic top view diagram illustrating one of the substrates of an electronic device according to a first embodiment of the present disclosure.

FIG. 2 is a schematic cross-sectional diagram illustrating the electronic device according to the first embodiment of the present disclosure.

FIG. 3 is a schematic cross-sectional diagram illustrating a first supporting member according to the first embodiment of the present disclosure.

FIG. 4 is a schematic diagram illustrating a method of forming a first supporting member by a first pattern of a photomask according to some embodiments of the present disclosure.

FIG. 5 is a schematic top view diagram illustrating a second pattern of the photomask according to the first embodiment of the present disclosure.

FIG. 6 is a flowchart of a manufacturing method of the electronic device according to the first embodiment of the present disclosure.

FIG. 7 is a schematic cross-sectional diagram illustrating a first supporting member according to a second embodiment of the present disclosure.

FIG. 8 is a schematic cross-sectional diagram illustrating a first supporting member according to a third embodiment of the present disclosure.

FIG. 9 is a schematic cross-sectional diagram illustrating an electronic device according to a fourth embodiment of the present disclosure.

### DETAILED DESCRIPTION

The contents of the present disclosure will be described in detail with reference to specific embodiments and drawings. It is noted that, for purposes of illustrative clarity and being easily understood by the readers, the following drawings may be simplified schematic diagrams, and components therein may not be drawn to scale. The components and combinations thereof related to the present disclosure are shown to provide a clear description of the basic structure or implementation of the present disclosure, however, the actual components and layout may be more complicated. Additionally, the numbers, shapes and dimensions of the components in the drawings are just illustrative, and are not intended to limit the scope of the present disclosure. The detailed scales of components can be adjusted according to the designs.

Certain terms are used throughout the description and following claims to refer to particular components. As one skilled in the art will understand, electronic equipment manufacturers may refer to a component by different names. This document does not intend to distinguish between components that differ in name but not function. In the following description and claims, the terms “include” and “comprise” are used in an open-ended fashion, and thus should be interpreted to mean “include, but not limited to . . . ”.

The directional terms mentioned in this document, such as “up”, “down”, “front”, “back”, “left”, “right”, etc., are only directions referring to the drawings. Therefore, the directional terms are used for illustration, not to limit the present disclosure. In the drawings, each drawing shows the general characteristics of methods, structures and/or materials used in specific embodiments. However, these drawings should not be construed as defining or limiting the scope or nature covered by these embodiments. For example, the relative size, thickness and position of each layer, region and/or structure may be reduced or enlarged for clarity.

It should be understood that when a component or layer is referred to as being “on”, “disposed on” or “connected to” another component or layer, it may be directly on or directly connected to the other component or layer, or intervening components or layers may be presented (indirect condition). In contrast, when a component is referred to as being “directly on”, “directly disposed on” or “directly connected to” another component or layer, there are no intervening components or layers presented. In addition, the arrangement relationship between different components may be interpreted according to the contents of the drawings.

The terms “about”, “equal”, “identical” or “the same”, and “substantially” or “approximately” mentioned in this document generally mean being within 10% of a given value or range, or being within 5%, 3%, 2%, 1% or 0.5% of a given value or range.

The electrical connection can be direct electrical connection or indirect electrical connection. The electrical connection between two components can be achieved by direct contact in order to transmit electrical signals, and there may be no other components between them. The electrical connection between two components can also be bridged by the component between them in order to transmit electrical signals. Electrical connection can also be called coupling.

It should be understood that although the terms “first”, “second”, “third”, etc. may be used herein to describe various components, these components should not be limited by these terms. These terms may be used to distinguish different components in the specification. The same terms may not be used in the claims, and the components in the claims may be described by the terms “first”, “second”, “third”, etc. according to the order of the components presented in the claims. Thus, a first component discussed below may be termed as a second component in the claims.

It should be understood that according to the following embodiments, features of different embodiments may be replaced, recombined or mixed to constitute other embodiments without departing from the spirit of the present disclosure.

The comparison of thicknesses, areas and widths between different components in the following text can be conducted by optical microscope (OM), scanning electron microscope (SEM) and other suitable instruments, and the comparison can be conducted in the same photo or more than one photo.

The electronic device of the present disclosure may include, for example, a display device, a backlight device, an antenna device, a sensing device or a tiled device, but not limited thereto. The electronic device may be bendable, flexible or rollable electronic device. The display device may include a non-self-emissive display device or a self-emissive display device, but not limited thereto. The display device may include, for example, liquid crystal material, light-emitting diodes (LED), fluorescence material, phosphorescence material, quantum dots (QD), other suitable display medium, or combinations thereof, but not limited thereto. The antenna device may include, for example, a liquid crystal antenna or other kinds of antenna without liquid crystal, but not limited thereto. The sensing device may be used for detecting capacitance change, light, thermal energy or ultrasonic waves for example, but not limited thereto.

The electronic device may include electronic units, the electronic units may include passive components or active components, such as capacitors, resistors, inductors, diodes, etc. The diodes may include, for example, light emitting diodes or photodiodes, but not limited thereto. The light emitting diodes may include, for example, organic light emitting diodes (OLED), mini light emitting diodes (mini-LED), micro light emitting diodes (micro-LED) or quantum dots (QD) light emitting diodes, but not limited thereto. The tiled device may include, for example, a tiled display device of a tiled antenna device, but not limited thereto.

It should be noted that the electronic device of the present disclosure may be any combination of the aforementioned devices, but not limited thereto. In addition, the appearance of the electronic device may be rectangular, circular, polygonal, a shape with curved edges, or other suitable shapes. The electronic device may have peripheral systems such as a driving system, a control system, a light source system, a shelf system, etc., to support a display device, an antenna device, a wearable device (such as augmented reality or virtual reality device), a vehicle-mounted device (such as windshields), or a tiled device.

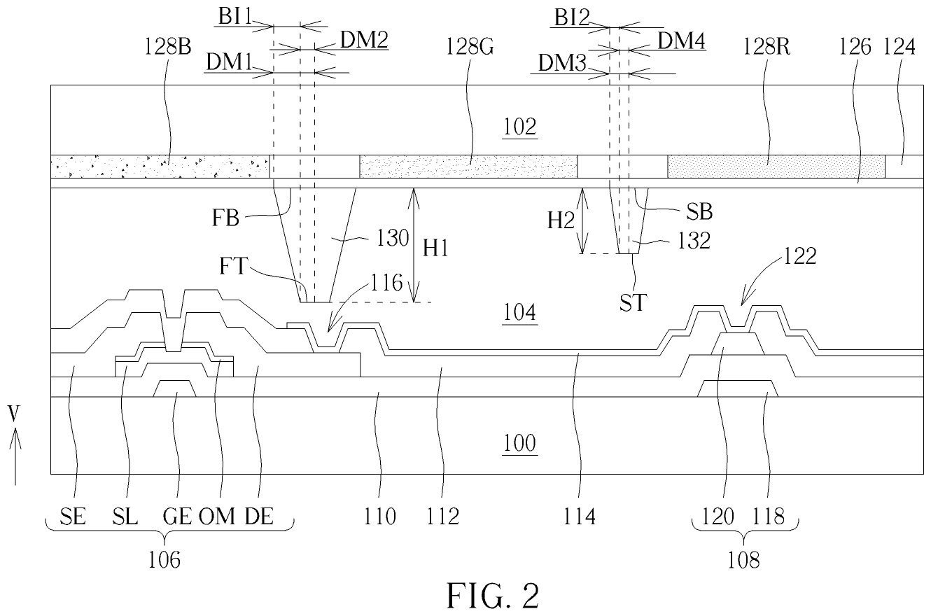

A direction V is shown in the following drawings. The direction V may be a normal direction or a top view direction, as shown in FIG. 2, the direction V may be perpendicular to a surface (such as a top surface or a bottom surface) of a substrate 100 or a substrate 102. The spatial relationship of the structure may be described according to the direction V in the following drawings.

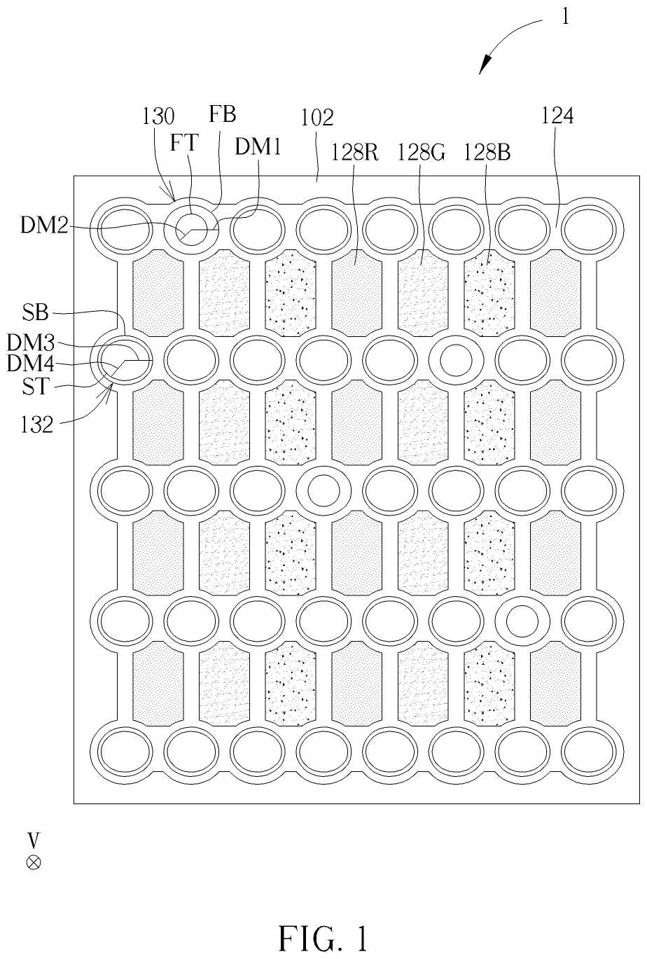

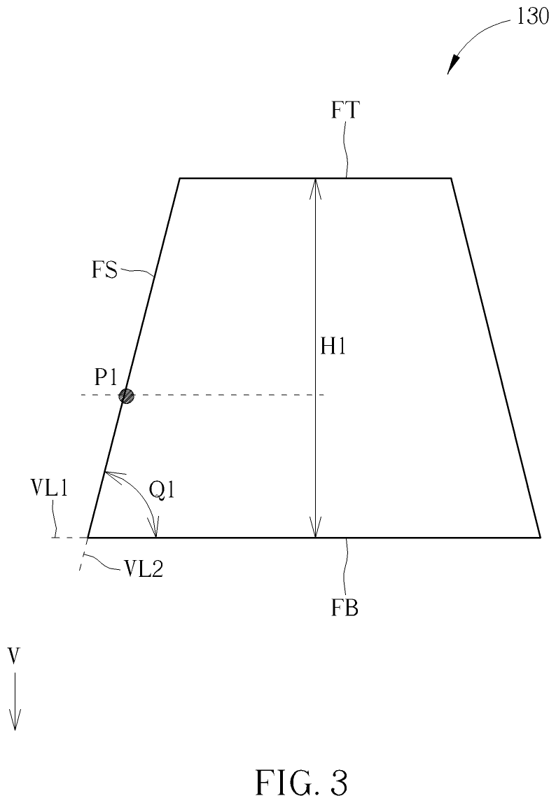

Please refer to FIG. 1 to FIG. 3, FIG. 1 is a schematic top view diagram illustrating one of the substrates of an electronic device according to a first embodiment of the present disclosure, FIG. 2 is a schematic cross-sectional diagram illustrating the electronic device according to the first embodiment of the present disclosure, and FIG. 3 is a schematic cross-sectional diagram illustrating a first supporting member according to the first embodiment of the present disclosure. In some embodiments, the display device may be a liquid crystal display device, but not limited thereto. In the following embodiments, the liquid crystal display device will be described as an example.

As shown in FIG. 2, the electronic device 1 may include a substrate 100, a substrate 102 and a liquid crystal layer 104. The substrate 102 may be disposed opposite to the substrate 100, and the liquid crystal layer 104 may be disposed between the substrate 100 and the substrate 102. The material of the substrate may include glass, quartz, sapphire, polymer (such as polyimide (PI), polyethylene terephthalate (PET)), and/or other suitable materials, but not limited thereto. The substrates can be flexible or rigid substrates, but it is not limited to this.

In some embodiments, the substrate 100 may be an array substrate, but not limited thereto. For example, the electronic device 1 may include at least one thin film transistor 106, at least one capacitor 108, an insulating layer 110, an insulating layer 112 and at least one electrode 114 disposed between the substrate 100 and the liquid crystal layer 104, but not limited thereto.

The thin film transistor 106 may include a gate GE, a semiconductor layer SL, a source SE and a drain DE. The gate GE may be disposed on the substrate 100, and the insulating layer 110 may cover the gate GE. The semiconductor layer SL may be disposed on the gate GE, and the insulating layer 110 may be disposed between the semiconductor layer SL and the gate GE. The source SE may be disposed on a portion of the semiconductor layer SL, and the drain DE may be disposed on another portion of the semiconductor layer SL.

The thin film transistor 106 may further include a plurality of ohmic contact electrodes OM, one of the ohmic contact electrodes OM may be disposed between the semiconductor layer SL and the source SE, and the other one of the ohmic contact electrodes OM may be disposed between the semiconductor layer SL and the drain DE.

The insulating layer 112 may be disposed on the source SE and the drain DE, the insulating layer 112 may have a contact hole 116, and the contact hole 116 may expose a portion of the drain DE. The electrode 114 may be disposed on the insulating layer 112 and may be electrically connected to the drain DE through the contact hole 116. The electrode 114 may be a pixel electrode, but not limited thereto.

The capacitor 108 may include an electrode 118 and an electrode 120, the electrode 118 may be disposed on the substrate 100, the electrode 120 may be disposed on the electrode 118, and the insulating layer 110 may be disposed between the electrode 118 and the electrode 120. The insulating layer 112 may be disposed on the electrode 120, and the insulating layer 112 may have a contact hole 122. The contact hole 122 may expose a portion of the electrode 120, and the electrode 114 may be electrically connected to the electrode 120 through the contact hole 122. Therefore, the thin film transistor 106 can be electrically connected to the capacitor 108.

Materials of the gate GE, the source SE, the drain DE, the electrode 118 and the electrode 120 may include metal, transparent conductive materials, other suitable conductive materials or combinations thereof, but not limited thereto. The electrode 114 may include the transparent conductive material, but not limited thereto. The material of the semiconductor layer SL may include amorphous silicon, polycrystalline silicon, metal oxide, other suitable semiconductor materials or combinations thereof, but not limited thereto. The material of the ohmic contact electrodes OM may include a highly doped semiconductor material, but not limited thereto. Materials of the insulating layer 110 and the insulating 112 may include inorganic insulating materials, organic insulating materials, other suitable insulating materials or combinations thereof, but not limited thereto.

In some embodiments, the substrate 102 may be a color filter substrate, but not limited thereto. For example, the electronic device 1 may include a plurality of color filters, a shielding layer 124 and an insulating layer 126 disposed between the substrate 102 and the liquid crystal layer 104, but not limited thereto. In some embodiments, a color filter layer may include a plurality of color filters 128R, a plurality of color filters 128G and a plurality of color filters 128B, the color filters 128R may be red, the color filters 128G may be green, and the color filters 128B may be blue, but not limited thereto.

As shown in FIG. 2, the color filter 128R, the color filter 128G, the color filter 128B and the shielding layer 124 may be disposed between the substrate 102 and the insulating layer 126, but not limited thereto. In addition, the color filter 128R, the color filter 128G, the color filter 128B and the shielding layer 124 may be disposed on the same plane, and the shielding layer 124 may be disposed between any two adjacent color filters, but not limited thereto. In addition, the height of the shielding layer 124 may be the same as the height of the color filter, but not limited thereto. In other embodiments, the color filters and the shielding layer 124 may be disposed on different planes, adjacent color filters may be connected with each other, and the shielding layer 124 may be disposed on and overlapped with the portion where two adjacent color filters are connected with each other, but not limited thereto.

The material of the color filters may include a resin capable of converting colors, but not limited thereto. The material of the shielding layer 124 may include an opaque resin, but not limited thereto. The shielding layer 124 may be a black matrix layer, but not limited thereto. The material of the insulating layer 126 may include inorganic insulating materials, organic insulating materials, other suitable insulating materials or combinations thereof, but not limited thereto.

FIG. 1 is a schematic top view diagram illustrating the structure on the substrate 102 of this embodiment. However, the insulating layer 126 in FIG. 2 is omitted in FIG. 1. As shown in FIG. 1, the electronic device 1 may include a plurality of first supporting members 130 and a plurality of second supporting members 132. The material of the first supporting members 130 and the second supporting members 132 may include resin, such as photoresist, but not limited thereto. The number of the second supporting members 132 may be greater than the number of the first supporting members 130, and the second supporting members 132 may be disposed adjacent to the first supporting members 130 and surround the first supporting members. For example, one of the first supporting members 130 may be surrounded by some of the second supporting members 132.

As shown in FIG. 2, the first supporting member 130 and the second supporting member 132 may be disposed between the substrate 100 and the substrate 102, and the first supporting member 130 and the second supporting member 132 may be overlapped with the shielding layer 124 in the direction V, thus the first supporting member 130 and the second supporting member 132 may be blocked by the shielding layer 124. In addition, a height H1 of the first supporting member 130 may be different from a height H2 of the second supporting member 132. In some embodiments, the height H1 of the first supporting member 130 may be greater than the height H2 of the second supporting member 132. The first supporting member 130 can be used as a main spacer, and the second supporting member 132 can be used as a sub-spacer, but not limited thereto.

In other embodiments, when the color filters and the shielding layer 124 are disposed on different planes, adjacent color filters may be connected with each other, the shielding layer 124 can be disposed on the portion where two adjacent color filters are connected with each other, and the first supporting member 130 or the second supporting member 132 may be disposed on the shielding layer 124 and may be overlapped with the portion where two adjacent color filters are connected with each other, but not limited thereto.

As shown in FIG. 2, the first supporting member 130 may include a first bottom surface FB and a first top surface FT, and the second supporting member 132 may include a second bottom surface SB and a second top surface ST. In some embodiments (as shown in FIG. 2), the first bottom surface FB and the second bottom surface SB may be close to the substrate 102, and the first top surface FT and the second top surface ST may be close to the substrate 100, but not limited thereto. In addition, the insulating layer 126 may be disposed between the first supporting member 130 and the shielding layer 124 and between the second supporting member 132 and the shielding layer 124, but not limited thereto.

The area of the first bottom surface FB may be greater than the area of the first top surface FT. When the shapes of the first bottom surface FB and the first top surface FT are similar to circles in the top view (as shown in FIG. 1), a radius DM1 of the first bottom surface FB may be greater than a radius DM2 of the first top surface FT, and the difference between the radius DM1 of the first bottom surface FB and the radius DM2 of the first top surface FT may be defined as a first radius bias BI1.

The area of the second bottom surface SB may be greater than the area of the second top surface ST. When the shapes of the second bottom surface SB and the second top surface ST are similar to circles in the top view (as shown in FIG. 1), a radius DM3 of the second bottom surface SB may be greater than a radius DM4 of the second top surface ST. The difference between the radius DM3 of the second bottom surface SB and the radius DM4 of the second top surface ST may be defined as a second radius bias BI2.

In the present disclosure, the first radius bias BI1 is greater than the second radius bias BI2. For example, the difference between the first radius bias BI1 and the second radius bias BI2 may be greater than or equal to 3 micrometers and less than or equal to 7 micrometers, but not limited thereto. When the first radius bias BI1 of the first supporting member 130 is large, the resilience of the first supporting member 130 after compression can be improved, and the internal space of the electronic device can be more effectively maintained. For example, the first supporting member 130 can more effectively support the liquid crystal layer 104 of the display device, the chance of damaging the display device can be reduced and Mura phenomenon can be mitigated, thereby improving the quality or reliability of the display device.

In some embodiments, the first radius bias BI1 may be greater than or equal to 2.1 micrometers and less than or equal to 10 micrometers, but not limited thereto. Within the range of the first radius bias BI1, the elastic coefficient of the first supporting member 130 may be greater than or equal to 40 mN (millinewton)/μm (micrometer) and less than or equal to 130 mN/μm when the radius DM2 of the first top surface FT is greater than or equal to 9 micrometers and less than or equal to 20 micrometers, but not limited thereto.

In some embodiments, within the aforementioned range of the first radius bias BI1, the elastic coefficient of the first supporting member 130 may be greater than or equal to 60 mN/μm and less than or equal to 80 mN/μm when the radius DM2 of the first top surface FT is 10 micrometers, but not limited thereto. In some embodiments, within the aforementioned range of the first radius bias BI1, the elastic coefficient of the first supporting member 130 may be greater than or equal to 100 mN/μm and less than or equal to 120 mN/μm when the radius DM2 of the first top surface FT is 15 micrometers, but not limited thereto.

Under the same radius DM2 of the first top surface FT, the elastic coefficient will become larger when the first radius bias BI1 becomes larger, and the pressure resistance of the first supporting member 130 can be improved. For example, under the same radius DM2 of the first top surface FT, the elastic coefficient can be increased by about 4 mN/μm when the radius DM1 of the first bottom surface FB is increased by 1 micrometer, but not limited thereto.

In some embodiments, the radius DM2 of the first top surface FT may be 13 micrometers. When the first radius bias BI1 is 1.98 micrometers, the amount of compression may be 1.745 micrometers, and the elastic coefficient may be 103 mN/μm. When the first radius bias BI1 is 4.7 micrometers, the amount of compression may be 1.559 micrometers, and the elastic coefficient may be 115 mN/μm. When the first radius bias BI1 is 6.83 micrometers, the amount of compression may be 1.407 micrometers, and the elastic coefficient may be 128 mN/μm.

In some embodiments, the radius DM2 of the first top surface FT may be 15 micrometers. When the first radius bias BI1 is 2 micrometers, the amount of compression may be 1.482 micrometers, and the elastic coefficient may be 121 mN/μm. When the first radius bias BI1 is 4.71 micrometers, the amount of compression may be 1.38 micrometers, and the elastic coefficient may be 130 mN/μm.

As shown in FIG. 3, the first supporting member 130 may include an angle Q1 between the first bottom surface FB and a side surface FS of the first supporting member 130, and the angle Q1 may be greater than or equal to 20 degrees and less than or equal to 60 degrees, but not limited thereto. In some embodiments, the angle Q1 may be greater than or equal to 30 degrees and less than or equal to 60 degrees, but not limited thereto. When the angle Q1 is within the above ranges, the first supporting member 130 may have a larger first radius bias BI1.

The measurement method of the angle Q1 is described below. A virtual line VL1 can be defined and the virtual line VL1 can be parallel to the first bottom surface FB. In addition, a point P1 can be set in a relatively smooth portion of the side surface FS within the range corresponding to 20% to 60% of the height H1, a tangent line of the point P1 on the side surface FS can be defined as a virtual line VL2, and the angle Q1 can be the included angle between the virtual line VL1 and the virtual line VL2.

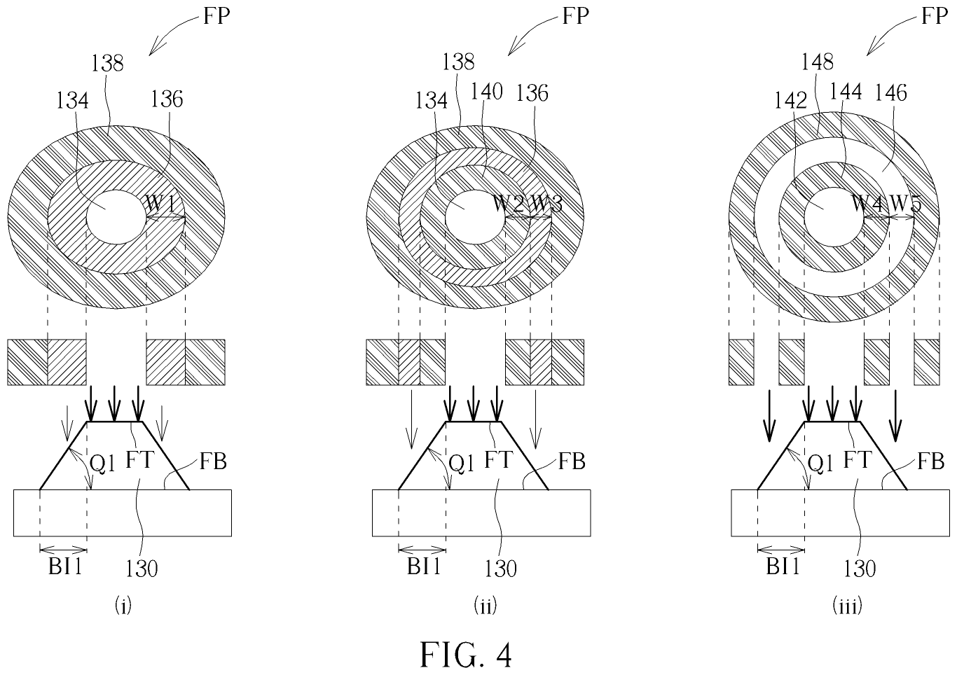

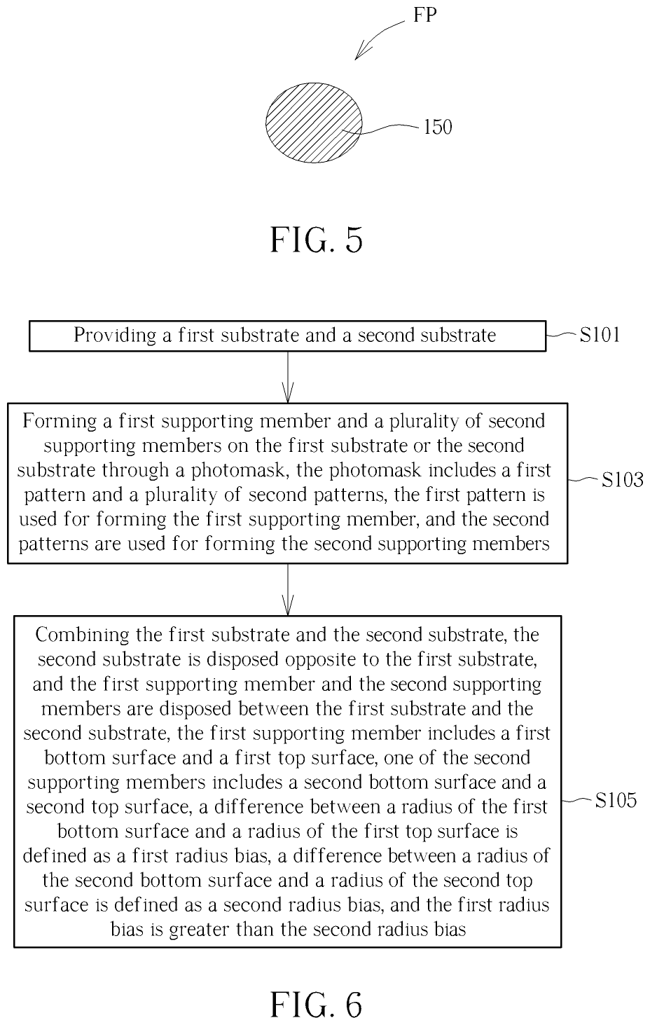

Please refer to FIG. 2 and FIG. 4 to FIG. 6, FIG. 4 is a schematic diagram illustrating a method of forming a first supporting member by a first pattern of a photomask according to some embodiments of the present disclosure, FIG. 5 is a schematic top view diagram illustrating a second pattern of the photomask according to the first embodiment of the present disclosure, and FIG. 6 is a flowchart of a manufacturing method of the electronic device according to the first embodiment of the present disclosure.

A manufacturing method of the electronic device in some embodiments is described below. As shown in FIG. 2, the substrate 100 and the substrate 102 may be provided first. Next, the gate GE and the electrode 118 may be formed on the substrate 100, and the insulating layer 110 may be formed on the gate GE and the electrode 118. Next, the semiconductor layer SL may be formed on the insulating layer 110, and the ohmic contact electrodes OM may be formed on the semiconductor layer SL. Next, the source SE and the drain DE may be formed on the ohmic contact electrodes OM and the electrode 120 may be formed on the insulating layer 110.

Next, the insulating layer 112 may be formed on the source SE, the drain DE and the electrode 120, and the contact hole 116 and the contact hole 122 may be formed in the insulating layer 112. The contact hole 116 may expose a portion of the drain DE, and the contact hole 122 may expose a portion of the electrode 120. Next, the electrode 114 may be formed on the insulating layer 112, the electrode 114 may extend into the contact hole 116 and electrically connect to the drain DE, and the electrode 114 may extend into the contact hole 122 and electrically connect to the electrode 120.

On the other hand, the color filter 128R, the color filter 128G, the color filter 128B and the shielding layer 124 may be formed on the substrate 102 first. Next, the insulating layer 126 may be formed on the color filter 128R, the color filter 128G, the color filter 128B and the shielding layer 124, and the first supporting member 130 and the second supporting member 132 may be formed on the insulating layer 126. However, in other embodiments, the first supporting member 130 and the second supporting member 132 may be formed on the substrate 100.

Next, the substrate 100 and the substrate 102 can be combined, the substrate 102 can be disposed opposite to the substrate 100, and the liquid crystal layer 104 can be disposed between the substrate 100 and the substrate 102. The method of forming the above components may at least include one or more patterning processes, which may include exposure and development processes, etching processes, other suitable processes, or combinations thereof, but not limited thereto.

A manufacturing method of the supporting member according to some embodiments is further described below. For example, as shown in FIG. 2, a material layer (such as a resin layer) may be formed on the insulating layer 126 first, and the first supporting member 130 and the second supporting member 132 may be formed by exposure and development processes through a photomask, but not limited thereto. The photomask may include a plurality of first patterns FP (as shown in FIG. 4) and a plurality of second patterns SP (as shown in FIG. 5). The first patterns FP may be used for forming the first supporting members 130, the second patterns SP may be used for forming the second supporting members 132, and the first patterns FP may be different from the second patterns SP.

The shapes of the first pattern FP of the photomask in FIG. 4 are only examples, and the first pattern FP may have different shapes according to different requirements. In an embodiment (i) of FIG. 4, the first pattern FP may include a full penetration portion 134, a half tone portion 136 and a full light-shielding portion 138. The full penetration portion 134 may be an opening for example. The size (such as area, diameter, etc.) of the full penetration portion 134 may be used to define the size of the first top surface FT of the first supporting member 130.

The half tone portion 136 may be disposed outside the full penetration portion 134 and surround the full penetration portion 134. The half tone portion 136 may for example be a semi-transparent film, and the transmittance of the semi-transparent film may be greater than or equal to 20% and less than or equal to 40%, but not limited thereto. For example, the transmittance of the half tone portion 136 in the embodiment (i) may be greater than or equal to 25% and less than or equal to 30%, but not limited thereto. In addition, a width W1 of the half tone portion 136 may be greater than or equal to 3 micrometers and less than or equal to 7 micrometers, but not limited thereto. For example, the width W1 of the half tone portion 136 in the embodiment (i) may be greater than or equal to 4 micrometers and less than or equal to 7 micrometers, but not limited thereto.

The full light-shielding portion 138 may be disposed outside the half tone portion 136 and surround the half tone portion 136, and the half tone portion 136 may be disposed between the full penetration portion 134 and the full light-shielding portion 138. The material of the full light-shielding portion 138 may be the material of the photomask, such as metal, but not limited thereto.

The angle Q1 of the first supporting member 130 formed through the first pattern FP of the photomask of embodiment (i) may be greater than or equal to 45 degrees and less than or equal to 55 degrees, but not limited thereto. The first radius bias BI1 of the first supporting member 130 of the embodiment (i) can be increased by about 4.4 micrometers compared to the supporting member formed through the pattern including only the full penetration opening, but not limited thereto.

The difference between an embodiment (ii) and the embodiment (i) is that the first pattern FP of the embodiment (ii) includes another full light-shielding portion 140 in addition to the full penetration portion 134, the half tone portion 136 and the full light-shielding portion 138. The full light-shielding portion 140 may be disposed between the full penetration portion 134 and the half tone portion 136. In addition, the material of the full light-shielding portion 140 may be the same as the material of the full light-shielding portion 138, but not limited thereto.

A width W2 of the full light-shielding portion 140 may be greater than or equal to 2 micrometers and less than or equal to 6 micrometers, and a width W3 of the half tone portion 136 may be greater than or equal to 3 micrometers and less than or equal to 7 micrometers, but not limited thereto. For example, in the embodiment (ii), the width W2 of the full light-shielding portion 140 may be greater than or equal to 2.5 micrometers and less than or equal to 5.5 micrometers, and the width W3 of the half tone portion 136 may be greater than or equal to 3 micrometers and less than or equal to 5 micrometers, but not limited thereto. In addition, the transmittance of the half tone portion 136 in the embodiment (ii) may be greater than or equal to 30% and less than or equal to 35%, but not limited thereto.

The angle Q1 of the first supporting member 130 formed through the first pattern FP of the photomask of the embodiment (ii) may be greater than or equal to 35 degrees and less than or equal to 50 degrees, but not limited thereto.

In the embodiment (iii) of FIG. 4, the first pattern FP may include a first full penetration portion 142, a first full light-shielding portion 144, a second full penetration portion 146 and a second full light-shielding portion 148. The first full penetration portion 142 and the second full penetration portion 146 may be openings for example, and the materials of the first full light-shielding portion 144 and the second full light-shielding portion 148 may be the same as the material of the full light-shielding portion 138, but not limited thereto.

The first full light-shielding portion 144 may be disposed outside the first full penetration portion 142 and surround the first full penetration portion 142. The second full penetration portion 146 may be disposed outside the first full light-shielding portion 144 and surround the first full light-shielding portion 144. The second full light-shielding portion 148 may be disposed outside the second full penetration portion 146 and surround the second full penetration portion 146. In other words, the first full light-shielding portion 144 and the second full penetration portion 146 may be disposed between the first full penetration portion 142 and the second full light-shielding portion 148, and the first full light-shielding portion 144 may be disposed between the first full penetration portion 142 and the second full penetration portion 146.

A width W4 of the first full light-shielding portion 144 may be greater than or equal to 2 micrometers and less than or equal to 6 micrometers, and a width W5 of the second full penetration portion 146 may be greater than or equal to 3 micrometers and less than or equal to 7 micrometers, but not limited thereto. For example, in the embodiment (iii), the width W4 of the first full light-shielding portion 144 may be greater than or equal to 2.5 micrometers and less than or equal to 4.5 micrometers, and the width W5 of the second full penetration portion 146 may be greater than or equal to 3 micrometers and less than or equal to 5 micrometers, but not limited thereto.

The angle Q1 of the first supporting member 130 formed through the first pattern FP of the photomask of the embodiment (iii) may be greater than or equal to 40 degrees and less than or equal to 50 degrees, but not limited thereto. The first radius bias BI1 of the first supporting member 130 of the embodiment (iii) can be increased by about 10 micrometers compared to the supporting member formed through the pattern including only the full penetration opening, but not limited thereto. In the embodiments (ii) and (iii), the first radius bias BI1 can also be adjusted by adjusting the ratio of the width W2 to the width W3 or the ratio of the width W4 to the width W5.

The shape of the second pattern SP of the photomask in FIG. 5 is only an example, and the second pattern SP may have different shapes according to different requirements. As shown in FIG. 5, the second pattern SP may include a half tone portion 150, and the size (such as area, diameter, etc.) of the half tone portion 150 may be used to define the size of the second top surface ST of the second supporting member 132. The transmittance of the half tone portion 150 may be greater than or equal to 25% and less than or equal to 35%, but not limited thereto. The angle between the second bottom surface SB and the side surface of the second supporting member 132 formed through the second pattern SP may be greater than or equal to 70 degrees and less than or equal to 90 degrees, but not limited thereto.

In the embodiment (i), the difference between the first radius bias BI1 of the first supporting member 130 formed through the first pattern FP and the second radius bias BI2 of the second supporting member 132 formed through the second pattern SP may be greater than or equal to 3 micrometers and less than or equal to 6 micrometers, but not limited thereto. In the embodiment (ii), the difference between the first radius bias BI1 of the first supporting member 130 formed through the first pattern FP and the second radius bias BI2 of the second supporting member 132 formed through the second pattern SP may be greater than or equal to 3 micrometers and less than or equal to 5 micrometers, but not limited thereto. In the embodiment (iii), the difference between the first radius bias BI1 of the first supporting member 130 formed through the first pattern FP and the second radius bias BI2 of the second supporting member 132 formed through the second pattern SP may be greater than or equal to 4 micrometers and less than or equal to 7 micrometers, but not limited thereto.

According to the method described above, some embodiments of the present disclosure may provide a manufacturing method of an electronic device which may at least include the steps in FIG. 6. It should be understood that the steps shown in FIG. 6 may not be complete, and other steps may be performed before, after or between any shown steps. Furthermore, some steps may be performed simultaneously or in a different order from that shown in FIG. 6. As shown in FIG. 6, the manufacturing method of the electronic device may at least include the following steps:
Step S101: providing a first substrate and a second substrate;
Step S103: forming a first supporting member and a plurality of second supporting members on the first substrate or the second substrate through a photomask, the photomask includes a first pattern and a plurality of second patterns, the first pattern is used for forming the first supporting member, and the second patterns are used for forming the second supporting members; and
Step S105: combining the first substrate and the second substrate, the second substrate is disposed opposite to the first substrate, and the first supporting member and the second supporting members are disposed between the first substrate and the second substrate, the first supporting member includes a first bottom surface and a first top surface, one of the second supporting members includes a second bottom surface and a second top surface, a difference between a radius of the first bottom surface and a radius of the first top surface is defined as a first radius bias, a difference between a radius of the second bottom surface and a radius of the second top surface is defined as a second radius bias, and the first radius bias is greater than the second radius bias.

In the above steps, the first substrate may be one of the substrate 100 and the substrate 102, and the second substrate may be the other one of the substrate 100 and the substrate 102.

The electronic device and the manufacturing method thereof of the present disclosure are not limited to the aforementioned embodiment. The following description continues to detail other embodiments. To simplify the description and show the difference between other embodiments and the above-mentioned embodiment, identical components in each of the following embodiments are marked with identical symbols, and the identical features will not be redundantly described. In addition, the first supporting members in the following embodiments can also achieve the effect of the first supporting members in the above embodiment.

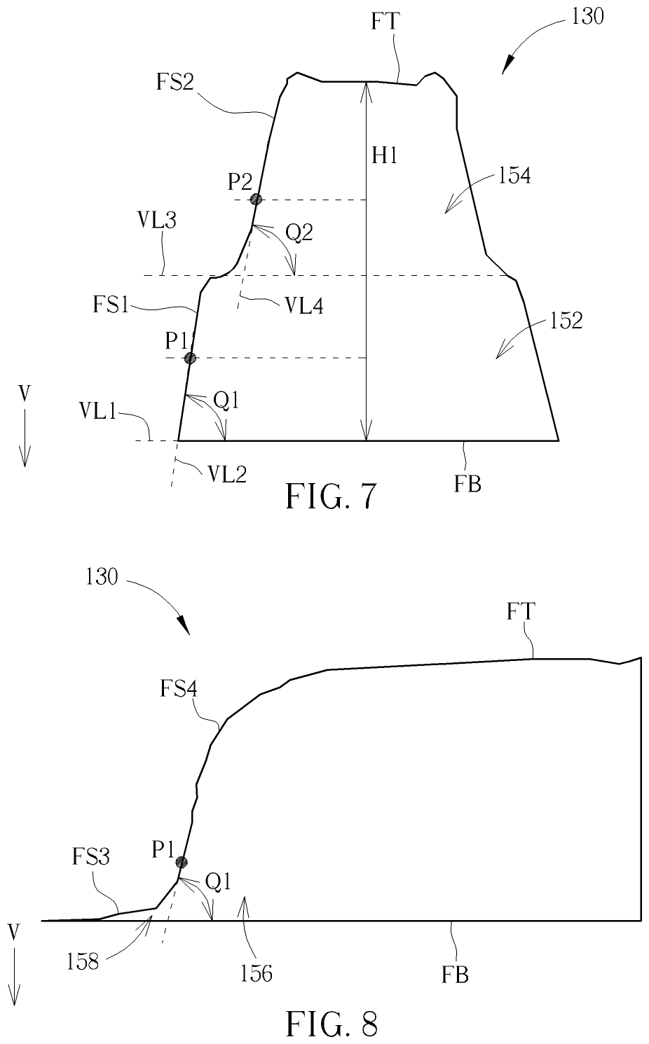

Please refer to FIG. 7, FIG. 7 is a schematic cross-sectional diagram illustrating a first supporting member according to a second embodiment of the present disclosure. In some embodiments, the cross-sectional structure of the first supporting member 130 may include a stepped structure, but not limited thereto. In some embodiments, the structure of the first supporting member 130 in FIG. 7 can also be obtained when the first supporting member 130 is formed through the first pattern FP of the photomask in FIG. 4, but not limited thereto. As shown in FIG. 7, the first supporting member 130 may include a portion 152 and a portion 154, the portion 154 may be disposed on the portion 152, and the width of the portion 152 may be greater than the width of the portion 154, but not limited thereto.

The portion 152 may include the angle Q1, and the angle Q1 may be greater than or equal to 20 degrees and less than or equal to 60 degrees, but not limited thereto. In some embodiments, the angle Q1 may be greater than or equal to 30 degrees and less than or equal to 60 degrees, but not limited thereto. The measurement method of the angle Q1 is described below. The virtual line VL1 may be defined and the virtual line VL1 may be parallel to the first bottom surface FB. In addition, the point P1 can be set in a relatively smooth portion of a side surface FS1 of the portion 152 within the range corresponding to 20% to 60% of the height H1, a tangent line of the point P1 on the side surface FS1 can be defined as the virtual line VL2, and the angle Q1 can be the included angle between the virtual line VL1 and the virtual line VL2.

The portion 154 may include an angle Q2, and the angle Q2 may be different from the angle Q1. In some embodiments, the angle Q1 may be greater than the angle Q2, but not limited thereto. The measurement method of the angle Q2 is described below. A point P2 may be set in a relatively smooth portion of a side surface FS2 of the portion 154 within a range corresponding to 40% to 80% of the height H1, and the height of the point P2 is greater than the height of the point P1. A tangent line of the point P2 on the side surface FS2 can be defined as a virtual line VL4. In addition, a virtual line VL3 can be defined, the virtual line VL3 can be parallel to the first bottom surface FB, and the angle Q2 can be the included angle between the virtual line VL3 and the virtual line VL4.

In addition, the first top surface FT of the first supporting member 130 may include an uneven surface. For example, the first top surface FT of the first supporting member 130 may be concave, but not limited thereto. The roughness of the first top surface FT can be increased when the first top surface FT of the first supporting member 130 is the uneven surface, thereby enhancing the friction of the first top surface FT. When the first supporting members 130 are disposed on the substrate 100 and the substrate 102 respectively, the uneven first top surfaces FT can improve the connection strength of two first supporting members 130. The above features can improve the ability of the first supporting members 130 to maintain the internal space of the electronic device after being compressed.

Please refer to FIG. 8, FIG. 8 is a schematic cross-sectional diagram illustrating a first supporting member according to a third embodiment of the present disclosure. In some embodiments, the structure of the first supporting member 130 in FIG. 8 can also be obtained when the first supporting member 130 is formed through the first pattern FP of the photomask in FIG. 4, but not limited thereto. In some embodiments, the first supporting member 130 may include a portion 156 and a portion 158, the portion 158 may be disposed at the bottom edge of the portion 156, and the height or volume of the portion 158 may be smaller than the height or volume of the portion 156, but not limited thereto. The slope of a side surface FS3 of the portion 158 may be less than the slope of a side surface FS4 of the portion 156, but not limited thereto. In addition, the stability of the first supporting member 130 can be increased when the first supporting member 130 has the portion 158.

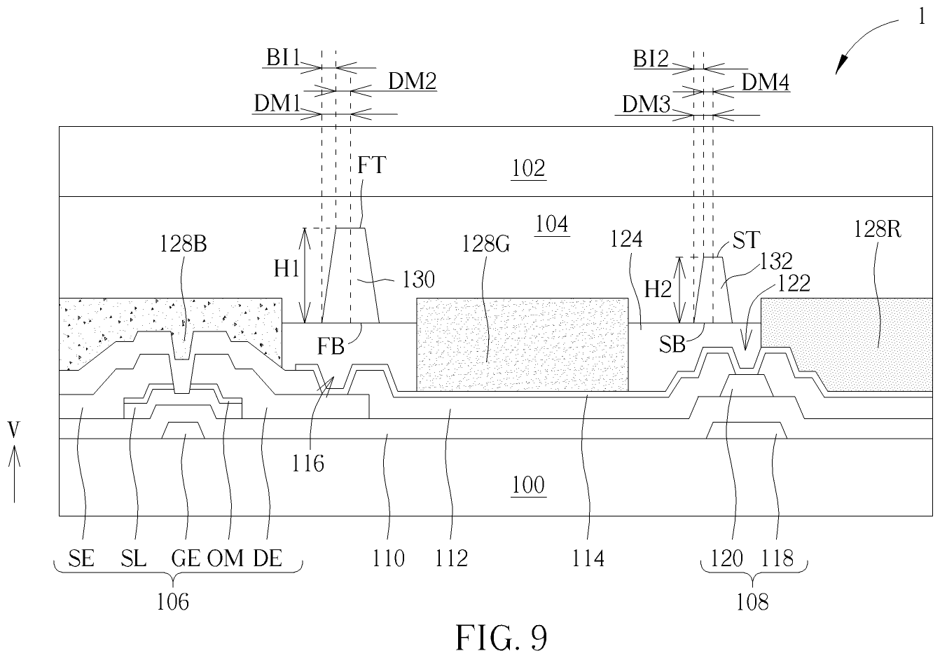

Please refer to FIG. 9, FIG. 9 is a schematic cross-sectional diagram illustrating an electronic device according to a fourth embodiment of the present disclosure. Different from the first embodiment (as shown in FIG. 2), the electronic device 1 of this embodiment may include a COA (color filter on array) structure. As shown in FIG. 9, the color filter 128R, the color filter 128G, the color filter 128B, the shielding layer 124, the first supporting member 130 and the second supporting member 132 may be disposed between the substrate 100 and the liquid crystal layer 104, but not limited thereto. The first bottom surface FB of the first supporting member 130 and the second bottom surface SB of the second supporting member 132 may be close to the substrate 100, and the first top surface FT of the first supporting member 130 and the second top surface ST of the second supporting member 132 may be close to the substrate 102, but not limited thereto.

In addition, the color filter 128R, the color filter 128G, the color filter 128B and the shielding layer 124 may be disposed on the same plane, the shielding layer 124 may be disposed between any two adjacent color filters, and the height of the shielding layer 124 may be less than the height of the color filters, but not limited thereto.

In this embodiment, the color filter 128R, the color filter 128G, the color filter 128B and the shielding layer 124 may be formed on the insulating layer 112 and the electrode 114 after the electrode 114 is formed on the substrate 100. Next, the first supporting member 130 and the second supporting member 132 may be formed on the shielding layer 124 through the first pattern FP and the second pattern SP of the photomask. Therefore, one of the differences between the first embodiment and this embodiment is that the first supporting member 130 and the second supporting member 132 of this embodiment may be formed on the substrate 100 through the first pattern FP and the second pattern SP of the photomask. Next, the substrate 100 and the substrate 102 may be combined, and the liquid crystal layer 104 may be disposed between the substrate 100 and the substrate 102.

To sum up, in the electronic device and the manufacturing method thereof in this disclosure, the resilience of the first supporting member after compression can be improved by increasing the first radius bias of the first supporting member, and the internal space of the electronic device can be more effectively maintained. For example, the first supporting member can more effectively support the liquid crystal layer of the display device, the chance of damaging the display device can be reduced and Mura phenomenon can be mitigated, thereby improving the quality or reliability of the display device.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An electronic device, comprising:
a first substrate;
a second substrate disposed opposite to the first substrate;
a first supporting member disposed between the first substrate and the second substrate, wherein the first supporting member comprises a first bottom surface and a first top surface; and
a plurality of second supporting members disposed between the first substrate and the second substrate, wherein the plurality of second supporting members are disposed adjacent to the first supporting member, and one of the plurality of second supporting members comprises a second bottom surface and a second top surface,
wherein a difference between a radius of the first bottom surface and a radius of the first top surface is defined as a first radius bias, a difference between a radius of the second bottom surface and a radius of the second top surface is defined as a second radius bias, and the first radius bias is greater than the second radius bias.

2. The electronic device according to claim 1, further comprising a liquid crystal layer disposed between the first substrate and the second substrate.

3. The electronic device according to claim 1, wherein the first supporting member is surrounded by the plurality of second supporting members.

4. The electronic device according to claim 1, wherein a height of the first supporting member is greater than a height of the one of the plurality of second supporting members.

5. The electronic device according to claim 1, wherein an elastic coefficient of the first supporting member is greater than or equal to 40 mN/μm and less than or equal to 130 mN/μm.

6. A manufacturing method of an electronic device, comprising:
providing a first substrate and a second substrate;
forming a first supporting member and a plurality of second supporting members on the first substrate or the second substrate through a photomask, wherein the photomask comprises a first pattern and a plurality of second patterns, the first pattern is used for forming the first supporting member, and the plurality of second patterns are used for forming the plurality of second supporting members; and
combining the first substrate and the second substrate, wherein the second substrate is disposed opposite to the first substrate, and the first supporting member and the plurality of second supporting members are disposed between the first substrate and the second substrate,
wherein the first supporting member comprises a first bottom surface and a first top surface, one of the plurality of second supporting members comprises a second bottom surface and a second top surface, a difference between a radius of the first bottom surface and a radius of the first top surface is defined as a first radius bias, a difference between a radius of the second bottom surface and a radius of the second top surface is defined as a second radius bias, and the first radius bias is greater than the second radius bias.

7. The manufacturing method of the electronic device according to claim 6, further comprising disposing a liquid crystal layer between the first substrate and the second substrate.

8. The manufacturing method of the electronic device according to claim 6, wherein the first pattern comprises a full penetration portion, a half tone portion and a first full light-shielding portion, the half tone portion is disposed outside the full penetration portion, and the half tone portion is disposed between the full penetration portion and the first full light-shielding portion.

9. The manufacturing method of the electronic device according to claim 8, wherein the first pattern further comprises a second full light-shielding portion disposed between the full penetration portion and the half tone portion.

10. The manufacturing method of the electronic device according to claim 6, wherein the first pattern comprises a first full penetration portion, a first full light-shielding portion, a second full penetration portion and a second full light-shielding portion, the first full light-shielding portion and the second full penetration portion are disposed between the first full penetration portion and the second full light-shielding portion, and the first full light-shielding portion is disposed between the first full penetration portion and the second full penetration portion.

11. The manufacturing method of the electronic device according to claim 6, wherein one of the plurality of second patterns comprises a half tone portion.
